(19) United States
(12) Patent Application Publication
(10) Pub. No.: US 2009/0213603 A1
(43) Pub. Date: Aug. 27, 2009

(54) PROJECTION GEAR KNOB

(76) Inventor: Yung-Fa LIN, Banqiao City (TW)

Correspondence Address: RABIN & BERDO, P.C.,, Suite 500, 1101 14 Street, N.W., Washington, DC, 20005, US

(21) Appl. No.: 12/037,313

(22) Filed: Feb. 26, 2008

(51) Int. Cl. B60Q 1/00

(52) U.S. Cl. 362/491

(57) ABSTRACT

A projection gear knob is assembled on an end portion of a car gear lever. A projection lamp, a projection film are accommodated and a transparent push-button is assembled in the gear knob, such that interesting, ornate, or beautiful projection film pattern is irradiated on inner top of the car. The projection lamp is freely switched by an outer light-transmissive push-button, so as to increase interest and beauty in the decoration of the car.

### BACKGROUND OF THE INVENTION

1. Field of Invention

The present invention relates to a projection gear knob combined with a car gear lever, capable of providing ornate, interesting, or beautiful projection pattern on inner top, thereby achieving more lively and active decoration of the car.

2. Related Art

Referring to FIG. 1, a conventional light emitting gear knob 10 recently available in the market mainly includes an accommodating body 101, a light emitting body 102, and an upper cover 103. A through hole 1011 is formed on a proper position at a bottom of the accommodating body 101, and a female thread 1012 is formed on upper section of an inner side of the accommodating body 101. A male thread 1031 capable of relatively being screwed with the female thread 1012 formed on the accommodating body 101 is formed at a bottom of the upper cover 103, two symmetrical tapped holes 1033 are formed at a bottom of the male thread 1013, and a light emitting patterned panel 1032 is assembled on a top of the upper cover 103. For the light emitting body 102, round slots 1022 corresponding to the tapped holes 1033 formed on the upper cover 103 are also disposed on two symmetrical sides of a circuit board 1021, a line 1023 is disposed on the circuit board 1021, and the line 1023 is connected to a plug 104 after passing through the through hole 1011 of the accommodating body 101. The circuit board 1021 is fixed by locking screws 105 in the tapped holes 1033 at the bottom of the upper cover 103, and then screwing the male thread 1031 of the upper cover 103 and the female thread 1012 of the accommodating body 101 with each other. However, when it intends to install the light emitting gear knob 10 on the car, it is necessary to insert the plug 104 connected to the line 1023 in a car motor room, and the installation is quite time consuming and laboursome. It is quite difficult for non-professionals to perform perfect installation, so improvement is required.

### SUMMARY OF THE INVENTION

In view of the above requirement, through hard research and personal experience of years in the field, the inventor designs a brand-new invention. The present invention is mainly directed to provide a projection gear knob capable of being installed easily and projecting a pattern.

In order to achieve the above objective, the projection gear knob of the present invention includes an outer case, a push-button, a projection lamp, and a switch. The push-button is transparent, the projection lamp and the push-button are assembled in the outer case, and a cell is assembled in the outer case for supplying electric power to the projection lamp. Then, the switch is assembled under the push-button. After the push-button is pressed, the switch electrically connected to the cell and the projection lamp is triggered, such that the projection lamp generates a light source. A projection film is assembled on an irradiating end of the projection lamp, and a pattern on the projection film is projected onto the inner top of the car through the irradiation of the light source.

In order to make the examiner have a further understanding of the content of the present invention, the description is given with the accompanying drawings in the following.

### BRIEF DESCRIPTION OF THE DRAWINGS

The present invention will become more fully understood from the detailed description given herein below for illustration only, and thus are not limitative of the present invention, and wherein:

FIG. 1 is a conventional light emitting gear knob;

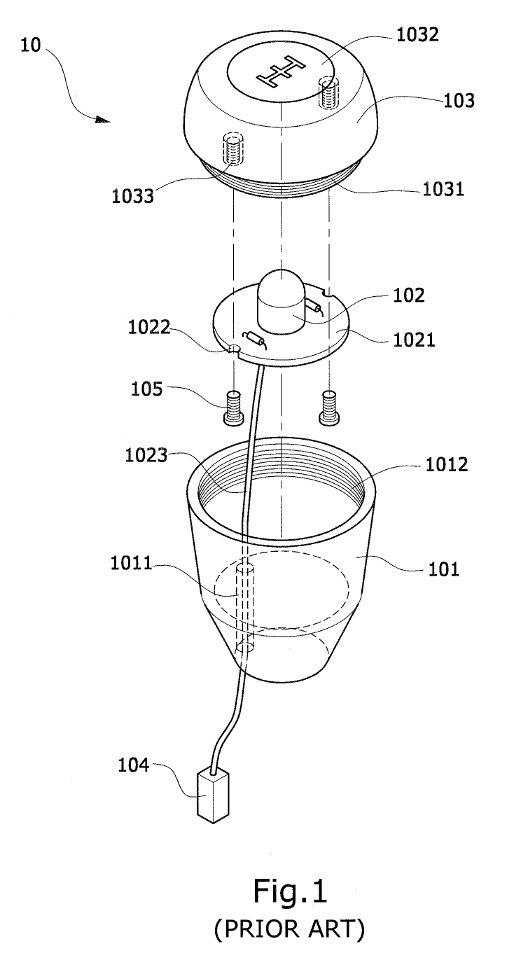

FIG. 2 is a schematic view of the installation of the present invention;

FIG. 3 is a three-dimensional exploded view of the present invention; and

FIG. 4 is an assembly cross-sectional view of the present invention.

### DETAILED DESCRIPTION OF THE INVENTION

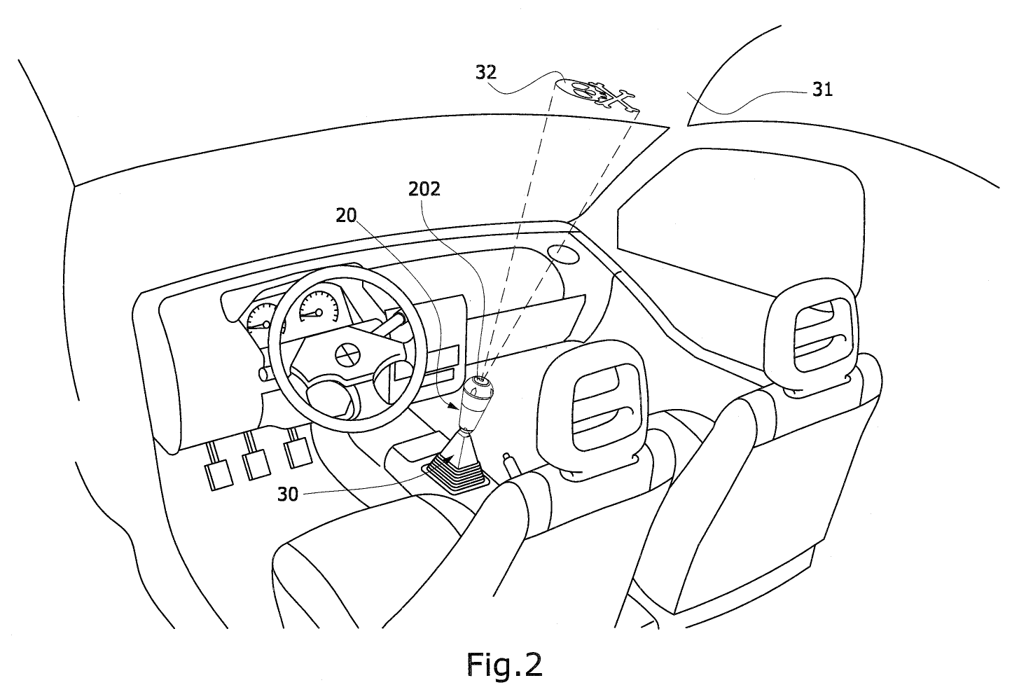

Referring to FIG. 2, a schematic view of the installation of the present invention is shown. A projection gear knob 20 as shown in the drawing is assembled on a car gear lever 30. When pressing a transparent push-button 202 on the projection gear knob 20, a projection lamp 203 (not shown) in the projection gear knob 20 projects lamp light upwardly, and the lamp light irradiates a projection film 2031 (not shown) having a pattern through an irradiating end assembled on the projection lamp 203, such that the pattern 31 on the projection film 2031 is projected to an inner top 32 of the car. The electric power of the projection lamp 203 is provided by an internally assembled cell 2063 (not shown), so as to eliminate the trouble of connecting the line to the car motor room or a car cigarette lighter for charging.

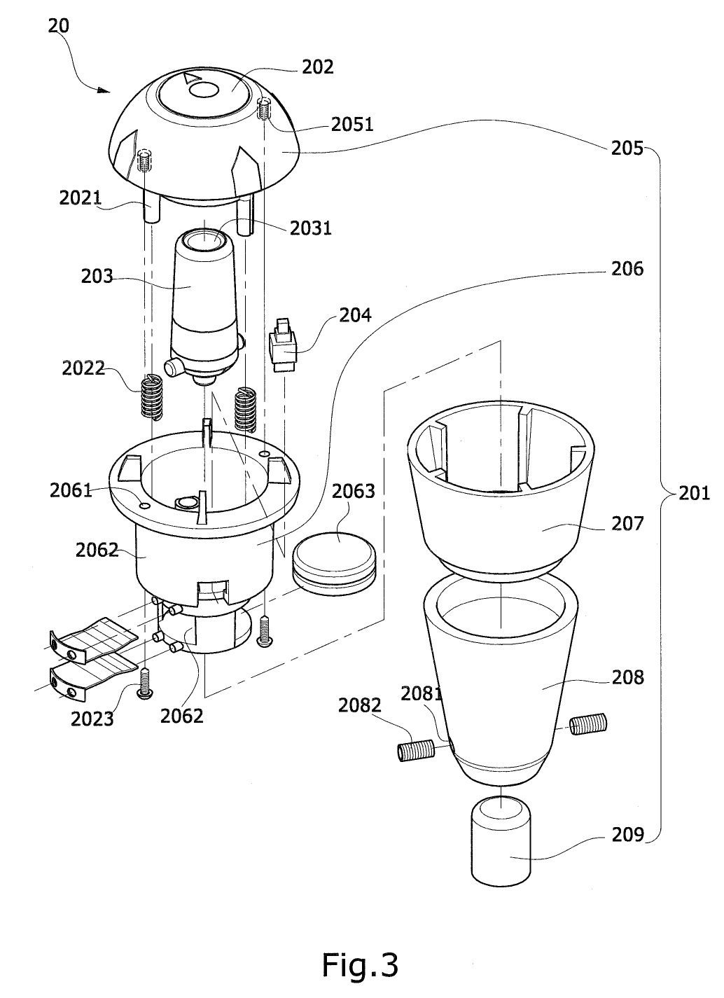

Referring to FIG. 3, a three-dimensional exploded view of the present invention is shown. The projection gear knob 20 as shown in the drawing includes an outer case 201, a push-button 202, a projection lamp 203, and a switch 204. The outer case 201 is composed of an upper cover 205, an inner base 206, a middle cover 207, a lower cover 208, and a bushing 209. The push-button 202 is transparent, a plurality of legs 2021 is formed on a lower end of the push-button 202, and a plurality of springs 2022 is sleeved on the legs 2021. A light emitting source (e.g. LED and bulb etc.) is assembled in the projection lamp 203, and a projection film 2031 is assembled on an illuminating end of the projection lamp 203. The switch 204 is assembled under the push-button 202. The upper cover 205 is sleeved on the push-button 202, and a plurality of first tapped holes 2051 is formed on a bottom of the upper cover 205. A plurality of first relative tapped holes 2061 corresponding to the first tapped holes 2051 on the bottom of the upper cover 20 is formed on an outer edge of an opening end of the inner base 206, and a cell container 2062 is formed on the bottom, for assembling more than one cell 2063 supplying the electric power to the projection lamp 203. The lower cover 208 is assembled on a lower end of the middle cover 207, and two symmetric second tapped holes 2081 are formed on the outer bottom of the lower cover 208. After a bushing 209 is assembled on the bottom of the lower cover 208, two inner hex head screws 2082 pass through the second tapped holes 2081, so as to fix the bushing 209 assembled on the bottom of the lower cover 208 by screwing.

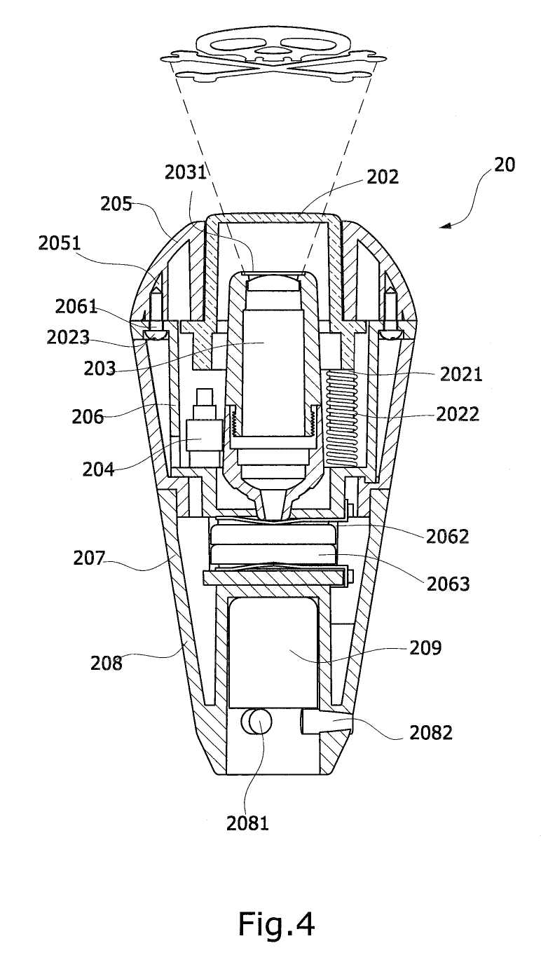

Referring to FIG. 4, an assembly cross-sectional view of the present invention is shown. In the projection gear knob 20 as shown in the drawing, the push-button 202 is transparent, and the upper cover 205 is sleeved on the push-button 202. Two legs 2021 extend from the bottom of the push-button 201, the springs 2022 are respectively sleeved on the legs 2021. After the springs 2022 is sleeved on the leg 2021, a part of the spring 2022 may be exposed out of the leg 2021. After the projection lamp 203 is placed in the inner base 206, the push-button 201 is placed in the inner base 206 and is located above the projection lamp 203, and more than one cell 2063 can be assembled on the cell container 2062 of the inner base 206, for supplying the electric power to the projection lamp 203. Then, a plurality of screws 2023 pass through the plurality of first relative tapped holes 2061 on the inner base 206, so as to be screwed with the corresponding first tapped holes 2051 on the bottom of the upper cover 205, such that the upper cover 205, the push-button 202, the projection lamp 203, and the inner base 206 are integrated as a whole. The lower cover 208 is assembled on the bottom of the inner base 206, two symmetric second tapped holes 2081 are formed on the lower side of the lower cover 208, and the two inner hex head screws 2082 pass through the second tapped holes 2081, so as to fix the bushing 209 assembled on the bottom of the lower cover 208. The push-button 202 is transparent, and the projection lamp 203 is located right under the push-button 202, so when the push-button 202 is pressed, after the spring 2022 partly exposed out of the leg 2021 contacts with the bottom of the inner base 206, an elastic force for springing back the push-button 202 is provided, and the lower end of the push-button 202 triggers the switch 204 electrically connected to the cell 2063 and the projection lamp 203, for providing the electric power of the cell 2063 to make the projection lamp 203 emit light. The projection film 2031 is assembled on a projecting end of the projection lamp 203, so when the light ray irradiates the projection film 2031 upwardly under the projection film 2031, the pattern on the projection film 2031 may be projected to the inner top of the car. Further, the bushing 209 is assembled on the gear lever, such that the projection gear knob 20 can be directly sleeved on the gear level, or be fixed on the gear lever by screwing. After the middle cover 207 is assembled with the lower cover 208, the lower cover 208 can be separated from the middle cover 207, such that the cell container 2062 is exposed, for conveniently replacing the cell 2063.

As described above, after the present invention is implemented accordingly, through the internally assembled cell and the projection film assembled on the irradiating end of the projection lamp, a projection gear knob, capable of being installed easily and projecting the pattern on the inner top of the car, can be surely achieved.

The invention is thus described, and it will be obvious that the same may be varied in many ways. Such variations are not to be regarded as a departure from the spirit and scope of the invention, and all such modifications as would be obvious to one skilled in the art are intended to be included within the scope of the following claims.

To sum up, the function of the projection gear knob of the present invention has industrial applicability, novelty, inventiveness, and other requirements of patentability of the utility model. The applicant applies to the Intellectual Property Office for the utility model according to the patent law.

What is claimed is:

1. A car projection gear knob, comprising:
an outer case;
a transparent push-button, assembled in the outer case, wherein at least one leg is formed under the push-button, and a spring is sleeved on the leg;
a projection lamp, assembled in the outer case, and located under the push-button, wherein a projection film is assembled on a projection end of the projection lamp; and
a switch, assembled in the outer case, under the push-button, and electrically connected to the cell and the projection lamp.

2. The projection gear knob as claimed in claim 1, wherein the outer case is composed of an upper cover, an inner base, a middle cover, a lower cover, and a bushing.

3. The projection gear knob as claimed in claim 2, wherein a plurality of first tapped holes is formed on a bottom of the upper cover.

4. The projection gear knob as claimed in claim 2, wherein a plurality of first relative tapped holes corresponding to the first tapped holes is formed on an outer edge of an opening end of the inner base, and a plurality of screws pass through the first relative tapped holes to be assembled with the first tapped holes.

5. The projection gear knob as claimed in claim 2, wherein a lower cover is assembled on a lower end of the middle cover.

6. The projection gear knob as claimed in claim 2, wherein a bushing is assembled on a lower end of the lower cover.

7. The projection gear knob as claimed in claim 2, wherein two symmetric second tapped holes are formed on the lower end of the lower cover, and the bushing on a bottom of the lower cover is fixedly assembled by passing two inner hex head screws through the second tapped holes.
